(19) United States
(12) Patent Application Publication
(10) Pub. No.: US 2011/0069676 A1
(43) Pub. Date: Mar. 24, 2011

(54) INFORMATION SERVICE AND EVENT SERVICE MECHANISMS FOR WIRELESS COMMUNICATIONS

(75) Inventors: Michelle Perras, Montreal (CA); Catherine M. Livet, Montreal (CA)

(73) Assignee: INTERDIGITAL PATENT HOLDINGS, INC., Wilmington, DE (US)

(21) Appl. No.: 12/885,238

(22) Filed: Sep. 17, 2010

Related U.S. Application Data
(60) Provisional application No. 61/243,667, filed on Sep. 18, 2009.

(51) Int. Cl. H04W 4/16

(52) U.S. Cl. 370/331

(57) ABSTRACT

A WTRU includes a transceiver and a media independent handover (MIH) function (MIHF), which transmits via the transceiver a request to set information in an external device. The MIHF receives a response to the request to store the information in the network node indicating that the request to store the information in the network node was successful.

### CROSS REFERENCE TO RELATED APPLICATIONS

This application claims the benefit of U.S. provisional application No. 61/243,667 filed on Sep. 18, 2009, the contents of which are hereby incorporated by reference herein.

### FIELD OF INVENTION

This application is related to wireless communications.

### BACKGROUND

Device management (DM) includes different tools that a managing or controlling device (such as a network node or server) may use to remotely manage one or more client devices, such as wireless transmit/receive units (WTRUs), which may be mobile or stationary. For example, a mobile telephone manufacturer may want to upgrade the firmware on all of its mobile telephones to fix a defect. Accordingly, the mobile telephone manufacturer may use one of the different device management technologies to send firmware updates to all registered mobile telephones.

One example of a DM tool is the Open Mobile Alliance (OMA) DM protocol. OMA DM allows two-way communication between a server and a client, which enables device manageability. OMA DM also allows the client to notify the server that an update was successful or failed, enabling more reliable end-to-end firmware deployment.

Another technology that may be used for DM is media independent handover (MIH). As its name suggests, MIH was originally intended to facilitate media independent handover (e.g., handover of WTRUs between different broadband wireless access technologies, such as global system for mobile communication (GSM), universal mobile telecommunications system (UMTS) and code division multiple access (CDMA)). To accomplish this, the MIH may communicate event notifications using Event Service (ES), commands using Command Service (CS) and/or information using Information Service (IS) and, therefore, may be implemented for use in other technologies in which it is desirable to exchange information between a server and a WTRU (e.g., DM). The ES, CS and IS are made media-independent by adding an MIH function (MIHF) between the lower layers of the protocol stack (layer 2 (L2) and below) and the so-called MIH user (layer 3(L3) and above) in the MIH entity.

ES is broadly divided into two categories of events, link events and MIH events. Both link events and MIH events traverse a protocol stack in one direction, from lower layer to higher layer. For example, as illustrated in FIG. 1, an MIH client 100 has a mechanism for handling ES, which includes lower layers (L2 and below), an MIHF and an MIH user function. The link events originate from event source lower layer entities below the MIHF and terminate at the MIHF. MIH events either originate from within the MIHF or originate as link events that are then propagated by the MIHF to the MIH user.

Media independent information service (MIIS) provides a framework to discover and obtain network information within a geographical area to facilitate network selection and handover. For this purpose, the framework defines a query (or “pull”) information mechanism and a push information mechanism. As illustrated in FIG. 2, an MIIS client 201 uses the query information mechanism to request information from an MIIS server 221. The query information mechanism can be a remote query 231 (e.g., the MIH Client 201 on the mobile side can query MIIS from the MIH Information server 221 on the server side) or a local query 232, in which the query is totally within an MIH entity. As an example, FIG. 2 shows the local query 232 for the MIIS server 221, in which the MIH user 223 sends a MIH_get_information request 225 to the MIHF 222, and in response, receives an MIH_get_information confirm message 227 from the MIHF 222. A local query could also be performed by the MIIS client 201 (not shown). During the remote query 231, the MIH user 202 queries the server 204 by sending a MIH_get_information request 205 to the MIHF 203, which is forwarded as a request 206 to the MIHF 222. Within the MIIS server 221, a MIH_get_information indication 207 is sent from the MIHF 222 to the MIH user 223. The MIIS server 221 receives the request and generates a response 208, by sending a MIH_get_information response 209, 210 to the MIIS client 201. The requested information 212 is received by MIH user 202 with a MIH_get_information confirm message 211.

FIG. 3 illustrates the push information mechanism, which allows the MIIS server 321 to “push” information 324 to the MIIS client 301. Here, the MIH user 323 at the MIIS server 321 generates an MIH_push_information request 325, including the information that it desires to send, and sends it to the local MIHF 322. Responsive to receiving the MIH_Push_Information request 325, the MIHF 322 generates an MIH_push_information indication 326 and sends it to the remote MIHF 303 at the MIIS client 301, which then forwards the MIH_Push_Information indication 326 to the MIH user 327. If the request is successful, the MIIS client receives, accepts and applies and/or stores the received information 328. However, the MIIS server 321 does not receive acknowledgment 329 that the pushed information was successfully received. Thus, if the request is unsuccessful, the MIIS server 321 does not re-transmit it.

Additionally, the MIIS server 321 and the client MIH user 302 cannot set information on peer entities and receive a response confirming that the request has been accepted and successfully applied. Furthermore, the MIIS server 321 cannot obtain information from the client MIH user 302.

WTRUs are often configured for use with various applications (e.g., mobile television). Thus, it may be desirable for a network node (e.g., an application server, MIIS server, etc.) to freely exchange information with the application client running on the WTRU. Most DM tools define ways to send information from the server side (e.g., application server) to the mobile side (e.g., WTRU or client). However, they do not define ways to send information in the opposite direction, from the client to the application server. FIG. 4 shows an example for a typical ES definition that does not permit an MIH user to send events to either of the local or remote MIHFs. As shown in FIG. 4, the ES mechanism for a remote MIH event allows a remote entity 411 to communicate the remote MIH event between the MIHF 413 and MIHF 403, triggered by the link event received from the lower layers 414. The local entity 401 sends an MIH event from the MIHF 403 to the MIH user function 402. As shown in FIG. 4, a defined mechanism for the MIH user functions 402, 412 to send messages to the MIHFs 403, 413 is lacking.

### SUMMARY

A wireless transmit/receive unit (WTRU) includes a transceiver and a media independent handover (MIH) function (MIHF) configured to transmit a request to set information in a remote network node, such as a media independent information server. The network node includes a transceiver and an MIHF. The transceiver is configured to receive a request to set information in the network node. The MIHF of the network node is configured to transmit, responsive to receiving the request to store the information in the network node, a response to the request to store the information in the network node notifying that the request to store the information in the network node was successful. Alternatively, the WTRU may execute a local set information request, as generated by a MIH user application and sent to a local MIHF, which may respond with a set information confirm message back to the MIH user application.

In another embodiment, a MIH user application may be executed to generate a user event indication and send the indication to a local MIHF, which may respond by generating a MIH event message to be sent back to the user application. Alternatively, the MIHF may respond by generating and sending a remote MIH event message to a remote MIHF in a remote device.

In another embodiment, the network node may initiate a get information request to obtain media independent information from the WTRU. Responsive to the get information request, the WTRU sends the requested information as a get information response message, using a MIH user application and a MIHF. Alternatively, the network node may execute a local get information request and a get information confirm message locally between a MIHF and a MIH user application.

In another embodiment, the WTRU may execute a MIH user application and a MIHF to generate a push information message in response to having available information to be sent to a network node. The push information message is exchanged between the MIHF of the WTRU and a MIHF of the network node.

### BRIEF DESCRIPTION OF THE DRAWINGS

A more detailed understanding may be had from the following description, given by way of example in conjunction with the accompanying drawings wherein:

FIG. 1 shows an MIH client with a mechanism for handling event services;

FIG. 2 is a signal diagram of a pull information mechanism for media independent information service;

FIG. 3 is a signal diagram of a push information mechanism from a server for media independent information service;

FIG. 4 shows an event service mechanism during a remote event;

FIG. 5A is a system diagram of an example communications system in which one or more disclosed embodiments may be implemented;

FIG. 5B is a system diagram of an example radio access network and an example core network that may be used within the communications system illustrated in FIG. 5A;

FIG. 6 is a diagram of an example wireless transmit/receive unit (WTRU) that may be used within the communications system illustrated in FIGS. 5A-5B;

FIG. 7 is a signal diagram of a set information mechanism for media independent information service;

FIG. 8 is a signal diagram of an example implementation for the set information mechanism shown in FIG. 7;

FIGS. 9A and 9B show an event service mechanism that allows a user event to originate from a MIH user function;

FIG. 10 is a signal diagram for the event service mechanism shown in FIG. 9;

FIG. 11 is a signal diagram of a get information mechanism for media independent information service;

FIGS. 12A and 12B show an example implementation for the get information mechanism shown in FIG. 11;

FIG. 13 is a signal diagram of a push information mechanism from a client for media independent information service; and

FIG. 14 is a signal diagram of an example implementation for the push information mechanism shown in FIG. 13.

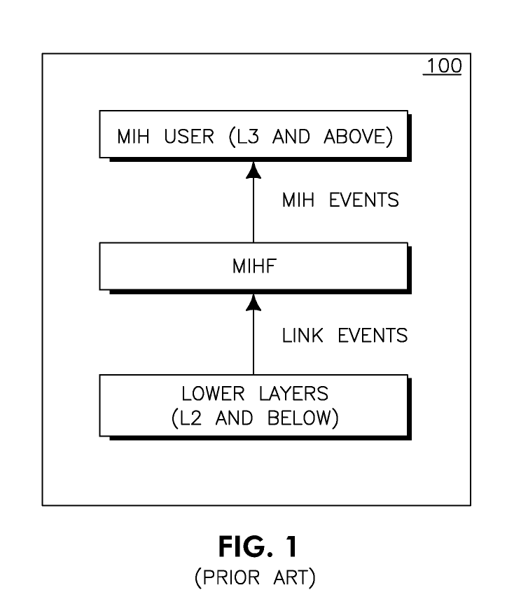

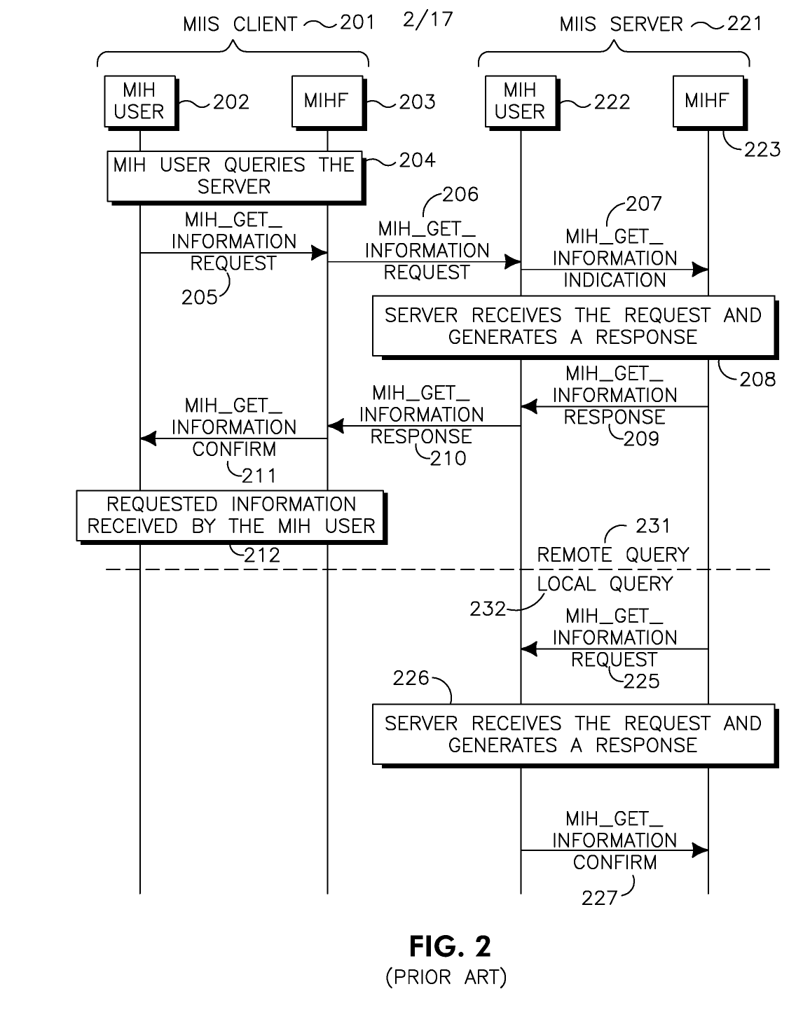

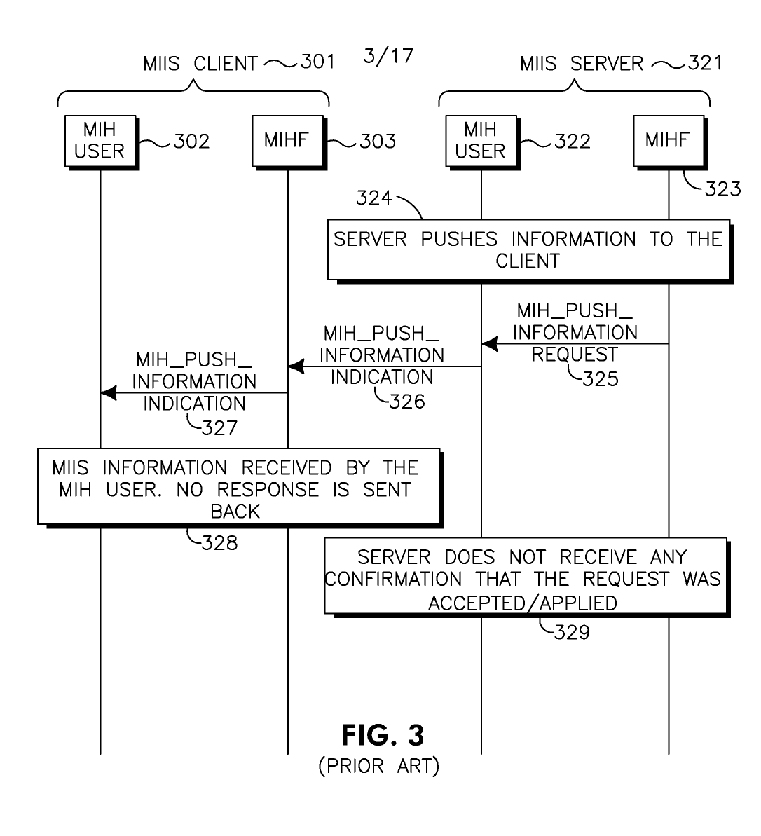

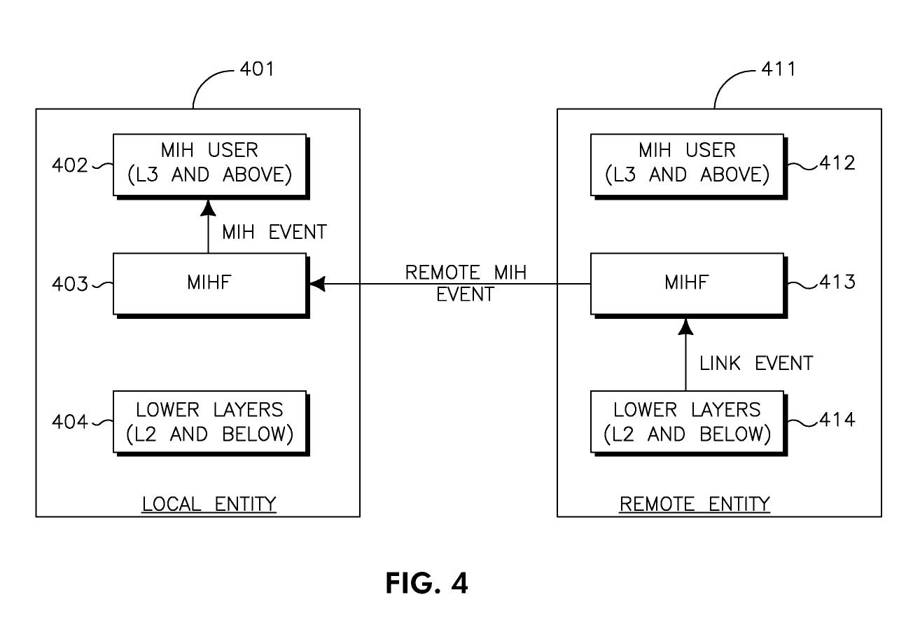

### DETAILED DESCRIPTION

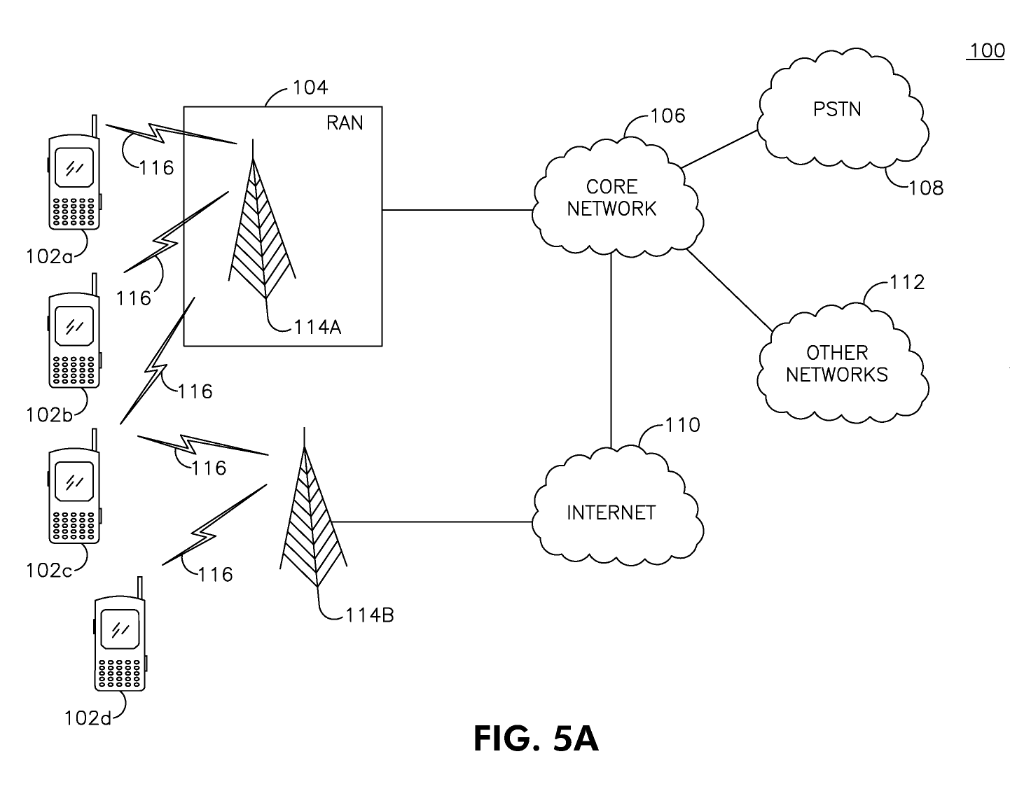

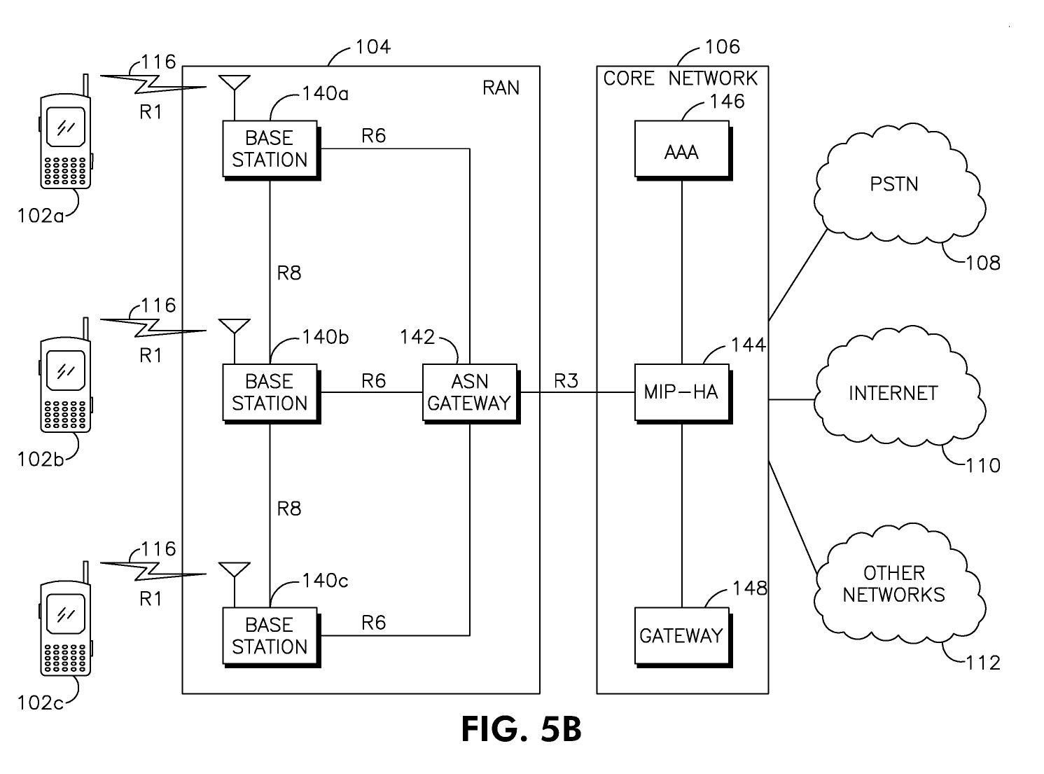

FIG. 5A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 5A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include a mobile node, user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications system 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, a network server, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 5A may be a wireless router, Home Node B, Home eNode B, network server, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 5A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 5A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 5A may be configured to communicate with the base station 114a, which may employ a cellular-based radio technology, and with the base station 114b, which may employ an IEEE 802 radio technology.

FIG. 5B is a system diagram of the RAN 104 and the core network 106 according to an embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 5B, the RAN 104 may include base stations 140a, 140b, 140c, and an ASN gateway 142, though it will be appreciated that the RAN 104 may include any number of base stations and ASN gateways while remaining consistent with an embodiment. The base stations 140a, 140b, 140c may each be associated with a particular cell (not shown) in the RAN 104 and may each include one or more transceivers for communicating with the WTRUs 102a, 102b, 102c over the air interface 116. In one embodiment, the base stations 140a, 140b, 140c may implement MIMO technology. Thus, the base station 140a, for example, may use multiple antennas to transmit wireless signals to, and receive wireless signals from, the WTRU 102a. The base stations 140a, 140b, 140c may also provide mobility management functions, such as handoff triggering, tunnel establishment, radio resource management, traffic classification, quality of service (QoS) policy enforcement, and the like. The ASN gateway 142 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 140a, 140b, 140c may be defined as an R8 reference point that includes protocols for facilitating WTRU handovers and the transfer of data between base stations. The communication link between the base stations 140a, 140b, 140c and the ASN gateway 142 may be defined as an R6 reference point. The R6 reference point may include protocols for facilitating mobility management based on mobility events associated with each of the WTRUs 102a, 102b, 102c.

As shown in FIG. 5B, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 144, an authentication, authorization, accounting (AAA) server 146, and a gateway 148. While each of the foregoing elements are depicted as part of the core network 106, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 144 may provide the WTRUs 102a, 102b, 102c with access to packet-switched networks, such as the Internet 110, to facilitate communications between the WTRUs 102a, 102b, 102c and IP-enabled devices. The AAA server 146 may be responsible for user authentication and for supporting user services. The gateway 148 may facilitate interworking with other networks. For example, the gateway 148 may provide the WTRUs 102a, 102b, 102c with access to circuit-switched networks, such as the PSTN 108, to facilitate communications between the WTRUs 102a, 102b, 102c and traditional land-line communications devices. In addition, the gateway 148 may provide the WTRUs 102a, 102b, 102c with access to the networks 112, which may include other wired or wireless networks that are owned and/or operated by other service providers.

Although not shown in FIG. 5B, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

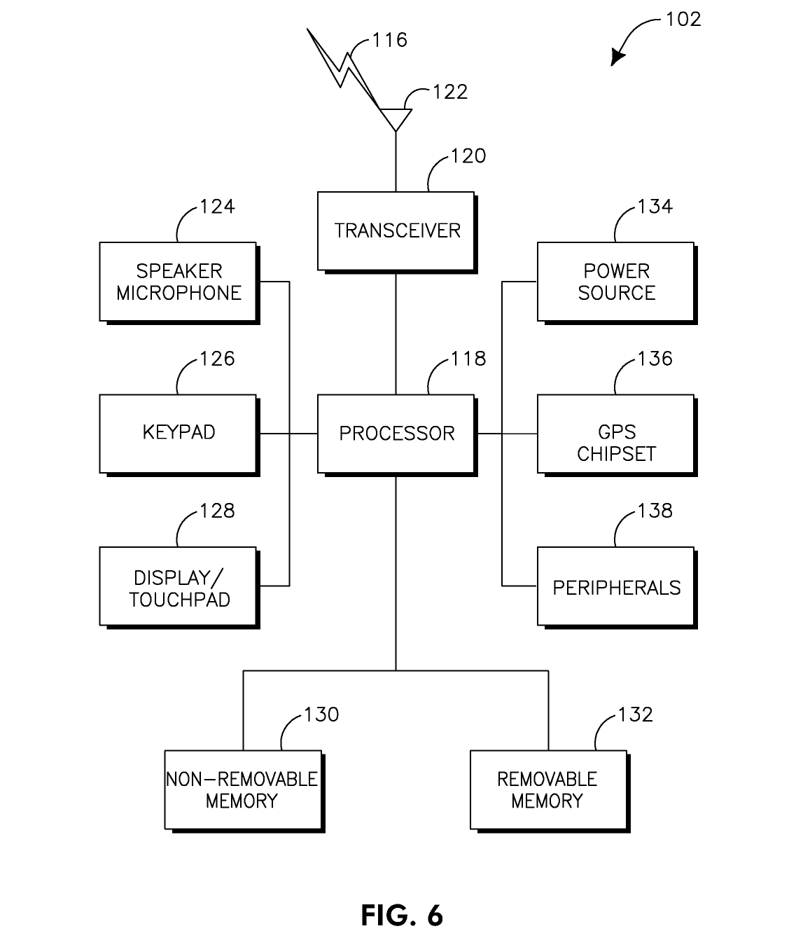

FIG. 6 is a block diagram of an example WTRU 102. As shown in FIG. 6, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 6 depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 6 as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

For some applications, it is desirable for the client to be able to freely and reliably send information to the application server. For example, mobile television signals can either be broadcast over a dedicated link between the application server and the WTRU or over a broadcast channel, depending, for example, on the number of users of a specific service. Here, the mobile television service providers may want to determine the number of users of a specific service because an increasing number of users of a specific service may justify the service provider's moving the specific service from a dedicated link to a broadcast technology. However, with the current standards used to deliver the broadcast services, it is not possible for the service provider to determine the number of listeners because their server cannot freely receive this information from the WTRU.

Embodiments of enhanced communication mechanisms between a client (e.g., application) on a WTRU and a network node (e.g., “server,” “application server” or “MIIS server”) are described herein. The MIH standard is used herein to illustrate the embodiments. However, the embodiments conceptually apply to all device management tools (e.g., OMA DM). In one example embodiment, the number of listeners in a broadcast services environment may be determined by an implementation of at least one of the enhanced communication mechanisms. However, the embodiments are not limited to this implementation.

One embodiment may include an application (e.g., an MIH user function of a WTRU) running on a device (e.g., a processor) that is configured to send information to a node in the network (e.g., an MIIS server) and to obtain a confirmation that the request is accepted and successful. Another embodiment may include an application (e.g., an MIH user function of a WTRU) running on a device that is configured to send information to a server (e.g., an MIIS server) via a notification mechanism (e.g., sending notifications to the MIHF on the server side via an ES mechanism). Additionally, the server side (e.g., MIIS server) may be configured to query the WTRU (e.g., at the MIH user function of the WTRU) via a get information mechanism (e.g., a MIH_get_information message). Additionally, a push notification (e.g., a MIH_push_information message) may allow execution of the MIH user function in the WTRU to push information to the MIIS server. The WTRU and server also include at least one enhanced communication mechanism that enables the application running on the WTRU to transfer information to the server and, in at least one embodiment, to receive confirmation that transferred information was received.

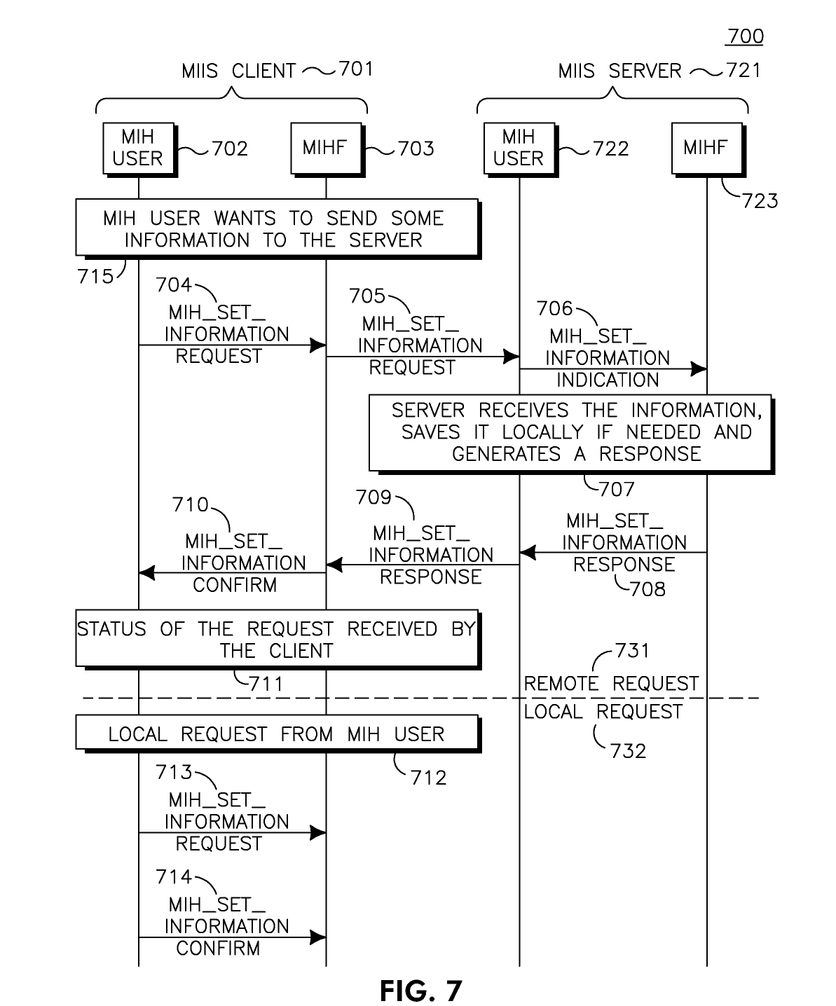

FIG. 7 illustrates an example of a new set information mechanism 700 that may be used as a remote request 731 or a local request 732 to set information by executing a local MIH user application. For a remote request 731, a local MIIS client 701 (e.g., a WTRU) has information available to be sent 715 to a remote device, shown here as a MIIS server 721. The MIIS client 701 has a MIH user application 702 and a local MIHF 703; the MIIS server 721 has a remote MIHF 722 and MIH user application 723. The local MIH user may send a MIH set information request 704 to the local MIHF 703, which may be forwarded as a MIH set information request 705 to the remote MIHF 722. The remote MIH user 723 may receive a MIH set information indication 706 from the remote MIHF 722 in response to the MIH set information request 705. Encoded within the set information request 705 and set information indication 706 is the payload information, which may be processed by the MIH user application 723, and stored in memory of the MIIS server 721 if needed. The MIH user 723 may generate a MIH set information response 708, which may be received by the remote MIHF 722, and forwarded as MIH set information response 709 to the local MIHF 703. The local MIH user 702 may receive a MIH set information confirm message 710 generated by the local MIHF 703. This confirmation message 710 is encoded with a status of the set information request 711, informing the MIIS client 701 whether the information sent to the remote server was successfully received and/or stored in memory at the MIIS server 721.

As mentioned, the MIH set information request may also be used locally. As illustrated, the local request 732 is initiated at 712, and the MIH user 702 of the MIIS client 701 may send a MIH set information request 713 to the local MIHF 703. In response, the MIH user 702 receives confirmation encoded as a MIH set information confirm message 714, which may indicate to the MIH user application whether the information was successfully received and/or locally stored in memory at the MIIS client.

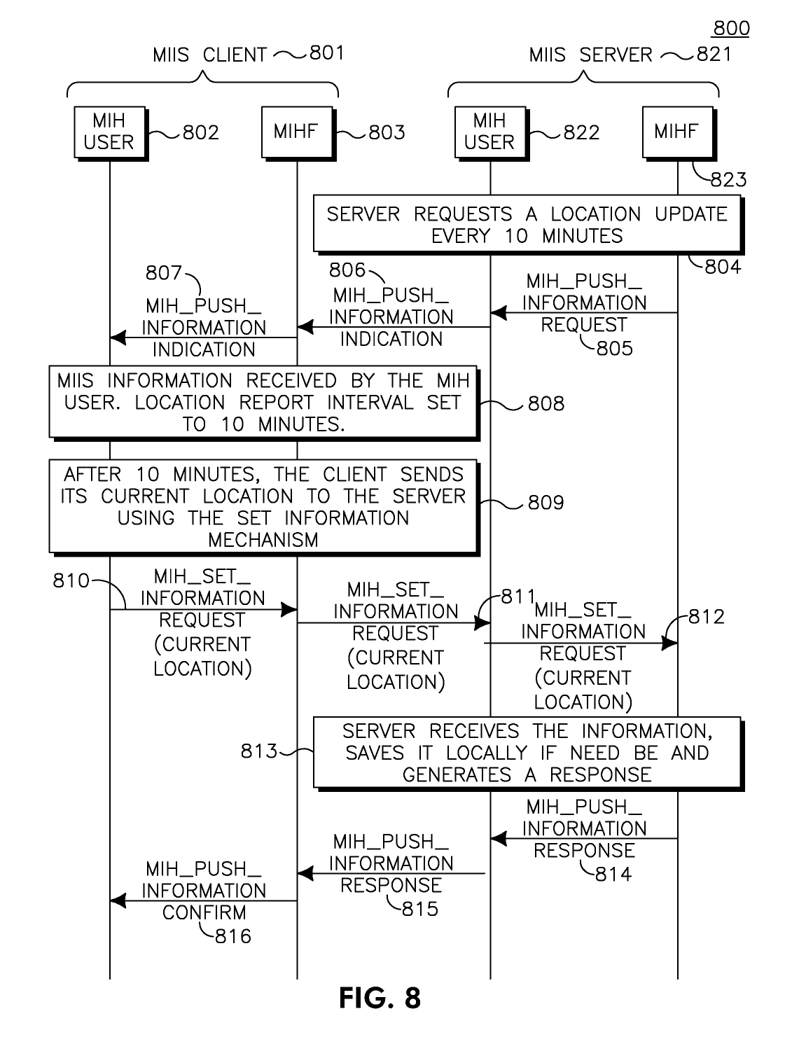

FIG. 8 illustrates an example implementation 800 of the MIH set information mechanism 700. In this example, the MIIS server 821 expects a periodic location update every 10 minutes from a mobile WTRU, shown here as MIIS client 801. At 804, a standard push information request 805 is initiated by the MIH user 823 of the MIIS server 821. The MIHF 822 receives the MIH push information request 805 and in response forwards a MIH push information indication 806 to the MIHF 803 at the MIIS client 801. The MIH push information indication 807 may be forwarded to the MIH user 802, allowing the location update request information to be received and processed 808 by the MIH user 802, setting a location report interval parameter to 10 minutes. After 10 minutes has elapsed at 809, the MIIS client 801 initiates the set information mechanism as described above for FIG. 7. First, the current location information may be encoded into a MIH set information request 810 by the MIH user 802, and sent to the MIHF 803. The MIH set information request may be forwarded 811 to the MIIS server at the MIHF 822, which may then generate and send a MIH set information indication 812 to the MIH user 823. Here at 813, the MIIS server 821 has received the current location information from the MIIS client 801, and may then prepare a response as a MIH set information response message 814, generated by the MIH user 823 and received at the MIHF 822. This response may be forwarded as MIH set information response 815 to the MIHF 803, which may then send a MIH set information confirm message 816 to the MIH user 802.

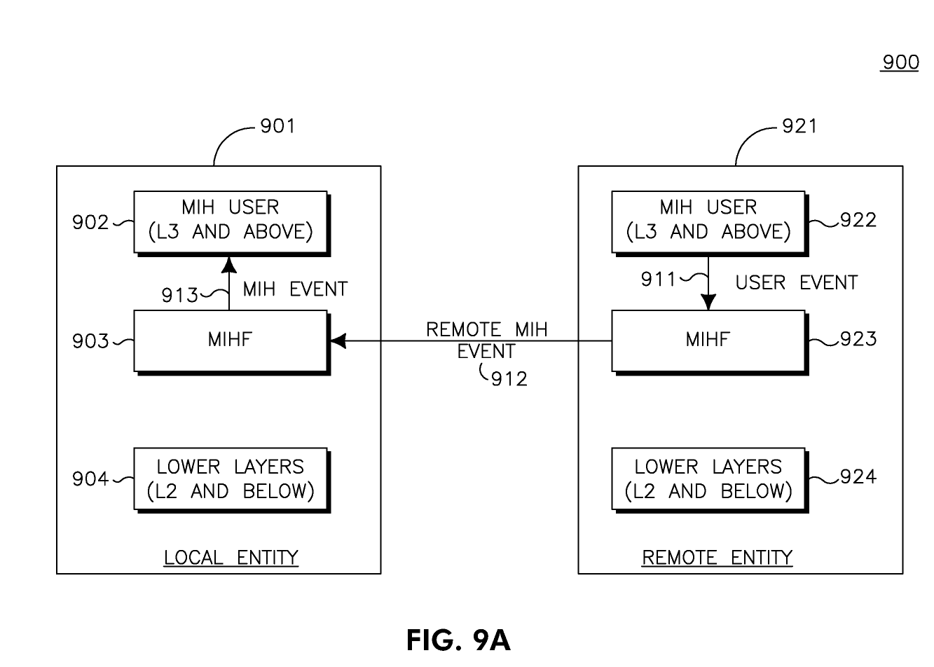

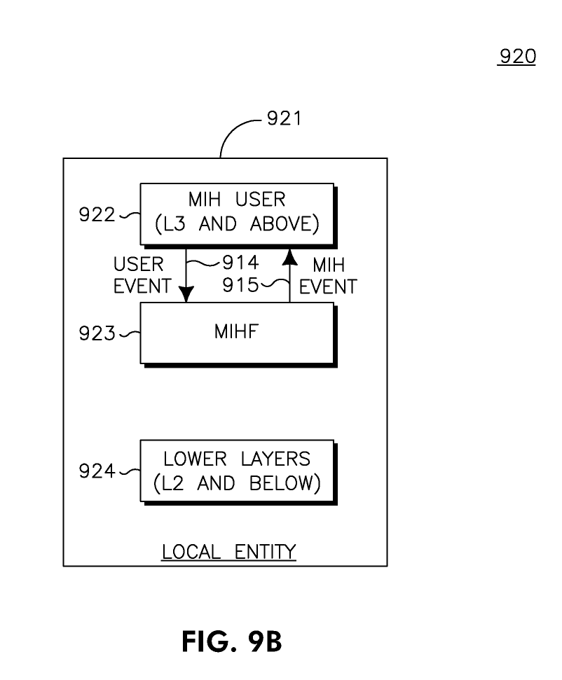

FIG. 9A shows an example of a remote MIH event with an event service mechanism 900 that allows a user event to originate from a MIH user function. A local entity 921 (e.g., a MIIS client or WTRU) is shown having lower layers (L2 and below) 924, an MIHF 923 and a MIH user function (L3 and above) 922. A remote entity 901 has lower layers 904, a MIHF 903 and a MIH user function 902. In this example, a remote MIH event 912 may be generated by executing the local MIHF 923 in response to a user event 911 that may be generated by execution of the MIH user function 922. The remote MIHF 903 receives the remote MIH event 912, and may send a MIH event 913 to the remote MIH user 902. Thus, for this event mechanism 900, local MIH user 922 is allowed to generate and transmit an event indication to a remote device 901.

FIG. 9B shows an example of an event service mechanism 920 having a local MIH event responsive to a local MIH user event. The local entity 921 (e.g., a MIIS client or WTRU) has a MIH user function 922, a local MIHF 923 and lower layers 924. The local MIH user function 922 may generate a user event 914 which may be forwarded to the local MIHF 923. In response, the MIHF 923 may generate and send a MIH event 915 back to the MIH user 922.

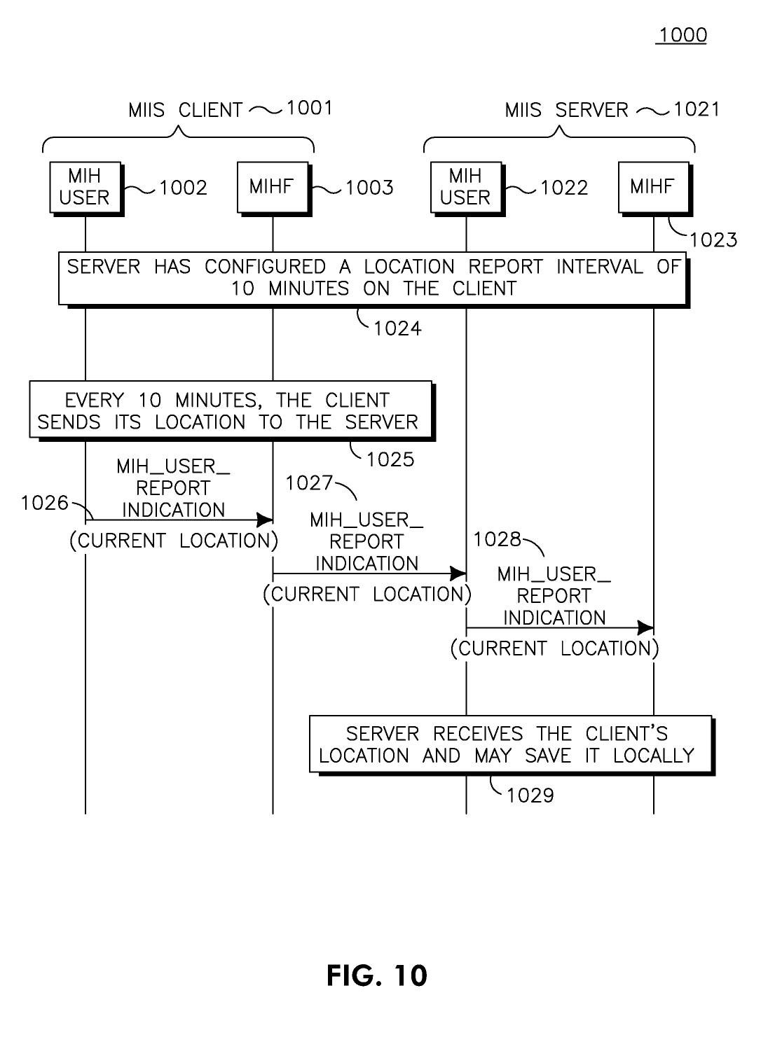

FIG. 10 shows an example of an implementation 1000 for the event service mechanism 900. In this example, the MIH event is shown as a MIH user report indication. An MIIS server 1021 has configured a location report interval of 10 minutes on a MIIS client 1001 via a push information mechanism 1024, such as described above. At 1025, ten minutes have elapsed and the MIH user 1002 of the MIIS client 1001 may be executed to generate an event in the form of a MIH user report indication 1026 with the current location information encoded in the message. The MIHF 1003 may receive the MIH user report indication 1026, and in response, generate and send a MIH user report indication 1027 to the server MIHF 1022. The MIH user 1023 may receive the MIH user report indication 1028 from the MIHF 1022, containing the current location information of the MIIS client 1001. The MIIS server 1021 may store the requested current location information 1029 in memory.

Another example of implementation for this event service mechanism is one in which the MIH user may be a mobile TV viewer application. Any changes performed at the application level may be learned by the MIHF via usage of the MIH event service (ES). For example, if the MIH user changes the viewed service to a different program, it may instantly notify the MIHF so that the network can have timely status of services provided to the MIH users.

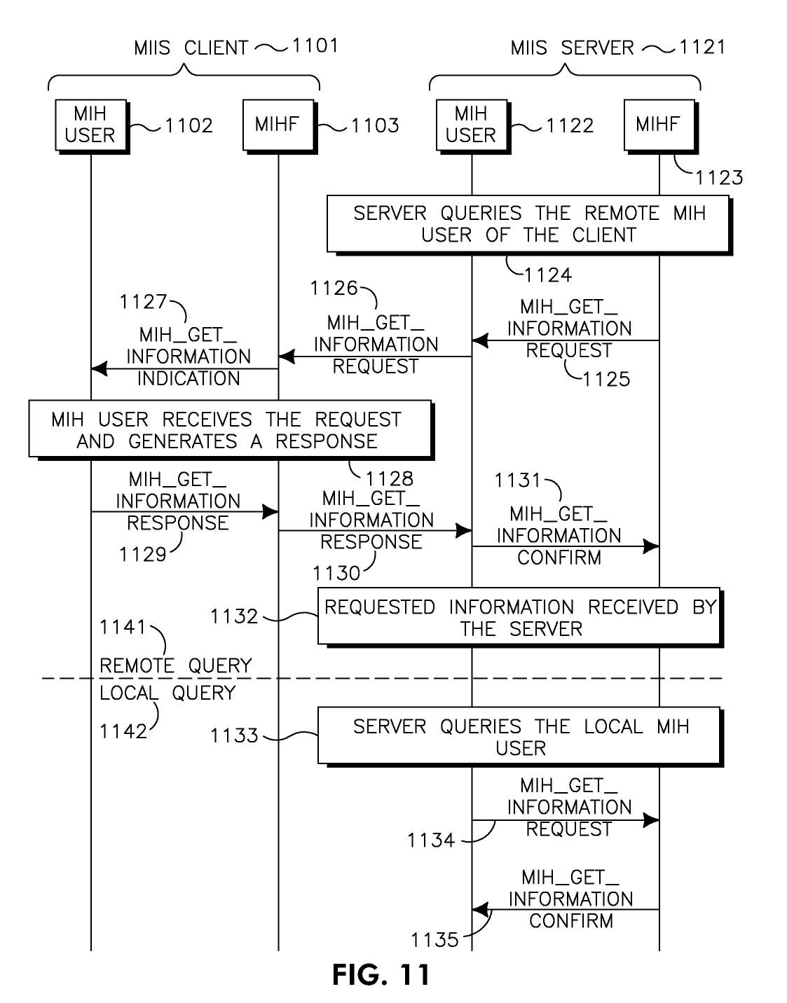

FIG. 11 illustrates an example of get information mechanism for exchanging media independent information. A MIIS server 1121 is shown having a MIHF 1122 and a MIH user 1123. Also shown is a MIIS client (e.g., a WTRU) having a MIH user function 1102 and a MIHF 1103. The MIIS server 1121 is configured to query 1124 the MIIS client's MIH user 1102. The MIH user 1123 may generate and send a MIH get information request 1125 to the MIHF 1122. The MIHF 1103 may receive the request forwarded as a MIH get information request 1126, and in response, may generate and send a MIH get information indication 1127 to the MIH user 1102. At 1128, the MIH user has received the request and may generate a response as follows. The MIH user 1102 may send a MIH get information response 1129 to the MIHF 1103. The MIH get information response may then be forwarded 1130 to the MIHF 1122, which may respond by generating and sending a MIH get information confirm message 1131 to the MIH user 1123.

FIG. 11 also shows a local query 1142, in which the MIIS server 1121 queries 1133 a local MIH user function. The MIHF 1122 may send a get information request 1134 to the local MIH user 1123. In response, the MIH user 1123 may generate a response and transmit the response with the requested information back to the local MIHF 1122 as a MIH get information confirm message 1135.

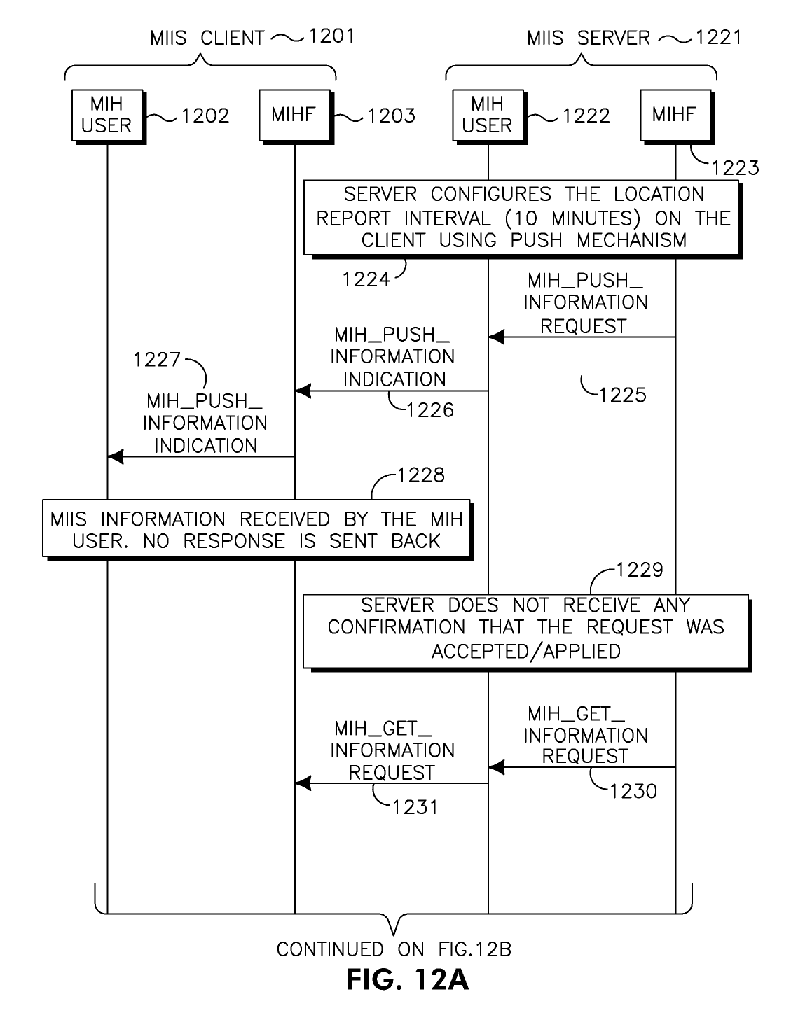

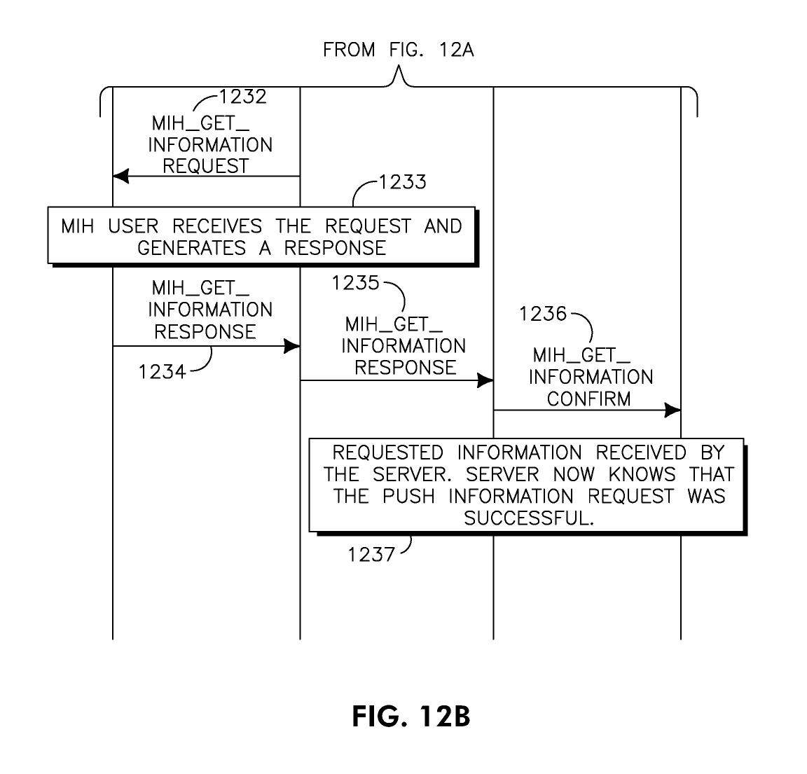

FIG. 12 shows an example of an implementation for the get information mechanism described above with respect to FIG. 11. A MIIS server 1221 is shown having a MIHF 1222 and a MIH user 1223. Also shown is a MIIS client (e.g., a WTRU) having a MIH user function 1202 and a MIHF 1203. The MIH user 1223 may initiate a push mechanism to configure a current location report 1224 from the MIIS client 1201 every 10 minutes. A MIH push information request 1225 may be sent to the MIHF 1222, forwarded as MIH push information indication 1226 to the MIHF 1203, and sent to the MIH user 1202 as MIH push information indication 1227. As a standard push mechanism, MIIS information may be received by the MIIS client 1201, but no response is sent back 1228 to the server 1221. Accordingly, the MIIS server 1221 initiates a get information mechanism 1229. The MIH user 1223 may generate and send a MIH get information request 1230 to the MIHF 1222. The MIHF 1203 may receive the request forwarded as a MIH get information request 1231, and in response, may generate and send a MIH get information indication 1232 to the MIH user 1202. At 1233, the MIH user has received the request and may generate a response as follows. The MIH user 1202 may send a MIH get information response 1234 to the MIHF 1203. The MIH get information response may then be forwarded (1235) to the MIHF 1222, which may respond by generating and sending a MIH get information confirm message 1236 to the MIH user 1223. At 1237, the MIIS server 1221 has received the requested information, and is informed that the push information request was successful.

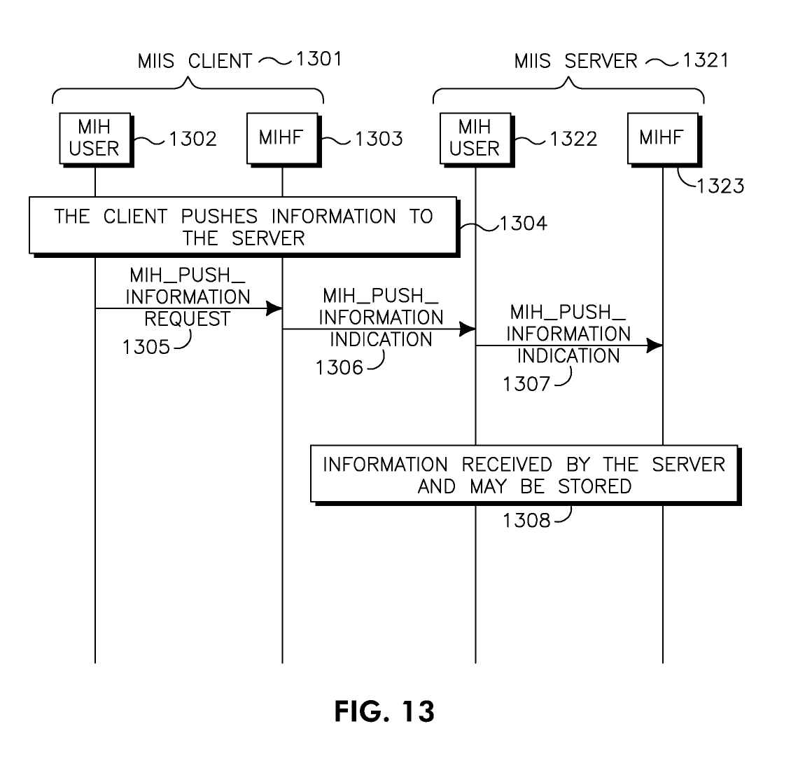

In FIG. 13, an embodiment is shown allowing a MIH user to send a push information request. In this example, a MIIS client 1301 (e.g., a WTRU) is configured to push information to a remote MIIS Server 1321. To do so, the MIH user 1302 may be executed to send a MIH push information request 1305 to the local MIHF 1303. The local MIHF 1303 may then generate and transmit to the remote MIHF 1322 an MIH push information indication 1306. Responsive to receiving the MIH push information indication 1306, the MIHF 1322 forwards a MIH push information indication 1307 to the MIH user 1323. At 1308, the information may be successfully received and may be stored in memory by the server 1321.

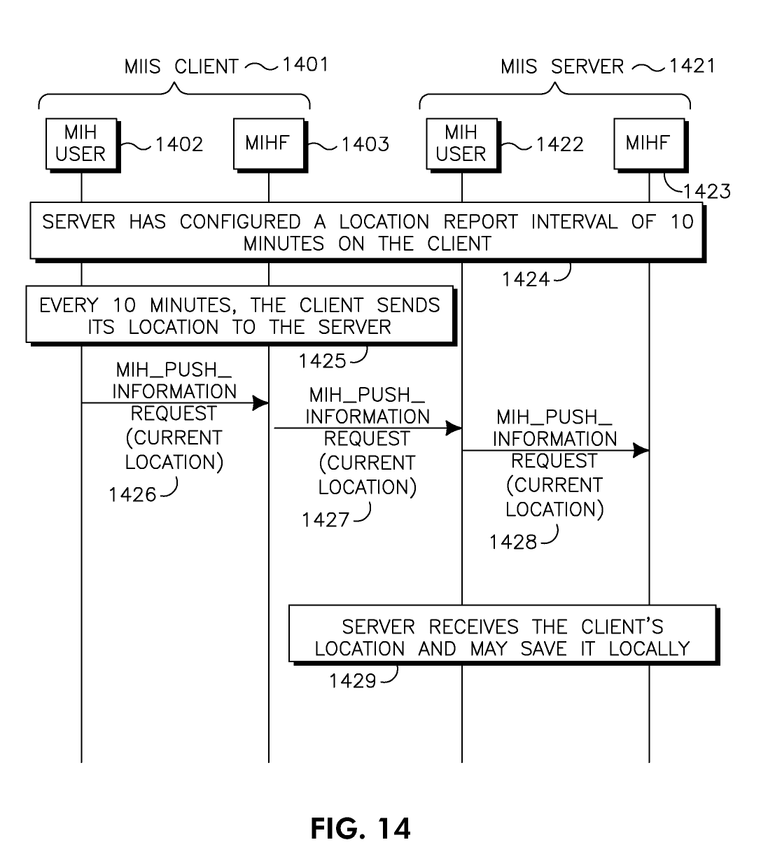

FIG. 14 shows an example implementation of the push mechanism described above for FIG. 13. As illustrated, a MIIS server 1421 at 1424 may configure a location report interval of, for example, 10 minutes on a MIIS client 1401 (e.g., a WTRU). Thereafter, every 10 minutes, the MIIS client 1401 may send its current location to the MIIS server 1421 using the MIH push information request. The MIH user 1402 may generate a MIH push information request 1426, and send it to the MIHF 1403. In response, the MIHF 1403 may then send a MIH push information indication 1427 to the MIHF 1422 and then may be forwarded to the MIH user 1423 as MIH push information indication 1428. Upon receiving the indication, the MIIS server 1421 may save the information locally 1429.

Although features and elements are described above in particular combinations, one of ordinary skill in the art will appreciate that each feature or element can be used alone or in any combination with the other features and elements. For example, the processor 118 shown in FIG. 6 may be implemented in a MIIS client device and configured to execute an MIH user application and an MIHF in accordance with any combination of the mechanisms described above with respect to FIGS. 7-14. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method implemented by a wireless transmit/receive unit (WTRU) for sending media independent information service (MIIS) information to a network node, the method comprising:
receiving a request for information from the network node;
generating a set information request including the requested information at a user application layer function;
sending the set information request to a local media independent handover function (MIHF);
sending the set information request from the local MIHF to a remote MIHF in the network node;
receiving a response from the network node at the local MIHF confirming that the network node successfully received the set information request; and
receiving a set information confirm message at the user application layer function from the local MIHF.

2. The method as in claim 1, wherein the set information request includes periodic location report information related to the location of the WTRU.

3. The method as in claim 1, wherein the network node is MIIS server.

4. A method implemented by a wireless transmit/receive unit (WTRU) for sending media independent event service information originated from a media independent handover (MIH) user application, the method comprising:
generating, at the MIH user application, a user event indication in response to a change related to the MIH user application; and
sending the user event indication to a local media independent handover function (MIHF).

5. The method as in claim 4, further comprising:
receiving, at the MIH user application, an MIH event indication from the MIHF in response to the user event indication to acknowledge that the user event indication was successfully received.

6. The method as in claim 4, further comprising:
sending a remote MIH event indication from the local MIHF to a remote MIHF at a network node in response to the user event indication.

7. The method as in claim 4, wherein the user event indication includes a user report indication of the WTRU's current location.

8. A method implemented by a wireless transmit/receive unit (WTRU) for sending a media independent information service (MIIS) information response to a network node, the method comprising:
receiving a get information request from the network node at a local media independent handover function (MIHF);
sending the get information request to a user application layer function;
generating a get information response including the requested information at the user application layer function;
sending the get information response to the local MIHF; and
sending the get information response from the local MIHF to a remote MIHF in the network node.

9. A method implemented by a wireless transmit/receive unit (WTRU) for sending requested media independent information service (MIIS) information to a remote device, the method comprising:
generating a push information request including the requested information at a user application layer function in response to having information available for transfer to a remote device;
sending the push information request to a local media independent handover function (MIHF); and
sending a push information indication from the local MIHF to a remote MIHF in the remote device in response to the push information request.

10. A wireless transmit/receive unit (WTRU) comprising:
a transceiver; and
a processor configured to execute a media independent handover (MIH) function (MIHF) to transmit via the transceiver a request to set information in a remote device.

11. The WTRU as in claim 10, wherein the processor is further configured to execute an MIH user application to transmit to the MIHF the request to set information.

12. The WTRU as in claim 11, further comprising a memory unit, wherein the MIH user application is stored in the memory unit.

13. The WTRU as in claim 10, wherein the processor is further configured to:
execute the MIHF a get information request from a remote device;
send the get information request to an MIH user application;
execute the MIH user application to generate a get information response including the requested information and to send the get information response to the local MIHF; and
execute the MIHF to send the get information response to a remote MIHF in a remote device.

14. A WTRU as in claim 10 wherein the processor is further configured to:
execute a user application layer function to generate a push information request to a remote device, the request in response to having information available for transfer to a remote device, and the request including the information;
execute the user application layer function to send the push information request to a local media independent handover function (MIHF); and
execute the MIHF to send a push information indication to a remote MIHF in the remote device in response to the push information request, the indication including the information.

15. A wireless transmit/receive unit (WTRU) comprising:
a transceiver; and
a processor configured to execute a media independent handover (MIH) user application to generate a user event indication in response to a change related to the MIH user application, and configured to send the user event indication to a local media independent handover function (MIHF).

16. The WTRU as in claim 15, wherein the processor is further configured to execute the MIH user application to receive an MIH event indication from the MIHF in response to the user event indication to acknowledge that the user event indication was successfully received.

17. The WTRU as in claim 15, wherein the processor is further configured to execute the local MIHF to send a remote MIH event indication to a remote MIHF at a network node in response to the user event indication.

18. The WTRU as in claim 15, wherein the user event indication includes a user report indication of the WTRU's current location.
